(19) United States
(12) Patent Application Publication
(10) Pub. No.: US 2022/0017691 A1
(43) Pub. Date: Jan. 20, 2022

(54) PROCESS FOR THE PRODUCTION OF ONE OR MORE POLYESTER COPOLYMERS, METHOD FOR THE PREPARATION OF ONE OR MORE OLIGOMERS, OLIGOMER COMPOSITION AND POLYESTER COPOLYMER

(71) Applicant: Avantium Knowledge Centre B.V., Amsterdam (NL)

(72) Inventors: Bing WANG, Amsterdam (NL); Gerardus Johannes Maria GRUTER, Amsterdam (NL); Robert-Jan Van Putten, Amsterdam (NL); Daniel Herbert WEINLAND, Amsterdam (NL)

(21) Appl. No.: 17/295,323

(22) PCT Filed: Nov. 20, 2019
(86) PCT No.: PCT/NL2019/050759

§ 371 Date: May 19, 2021

(30) Foreign Application Priority Data
Nov. 22, 2018 (NL) 2022053

(51) Int. Cl. C08G 63/78; C08G 63/672

(52) U.S. Cl. CPC C08G 63/78; C08G 63/672

(57) ABSTRACT

A process for the production of one or more polyester copolymers, comprising the steps of:

a) oligomerizing one or more, cyclic or bicyclic, diol monomers with a molar excess of one or more dicarboxylic monomers, which one or more dicarboxylic monomers comprise one or more oxalic monomers chosen from the group consisting of oxalic acid, oxalic monoesters and oxalic diesters, to yield one or more oligomers; and
b) polymerizing the one or more oligomers with one or more primary diol monomers.
A method for the preparation of one or more oligomers, which method comprises melt mixing one or more, cyclic or bicyclic, diol monomers with one or more oxalic monomers chosen from the group consisting of oxalic acid, oxalic monoesters and oxalic diesters, in a molar ratio of the one or more oxalic monomers to the one or more, cyclic or bicyclic, diol monomers of more than 1.1:1.

An oligomer composition obtainable by such method and a polyester copolymer obtainable by such process.

### FIELD OF THE INVENTION

The invention relates to a process for the production of one or more polyester copolymers, a method for the preparation of one or more oligomers, an oligomer composition and a polyester copolymer.

### BACKGROUND TO THE INVENTION

In recent times a tendency has grown to obtain a variety of chemical products from sustainable resources. Polymers and monomers constitute an important part of chemical products produced in the world today, about 80% of the bulk chemicals are monomers or monomer precursors. They therefore play a central role in the transition to a sustainable chemical industry. The majority of polymers today are produced from fossil fuel feedstock, giving after use (via incineration or degradation) rise to extensive greenhouse gases emissions globally. The development of so-called sustainable, preferably partly or wholly bio-based, polymers, could contribute significantly to the development of a more sustainable chemical industry.

JP2006161017 is directed to the provision of an isosorbide type biodegradable polymer which has a sharply improved heat-resisting property and describes an isosorbide type polyoxalate with a glass transition temperature (Tg) of more than 160° C. It is indicated that the polyoxalate may contain an additional repeating unit, provided such additional repeating unit does not impair a glass transition temperature of 160° C. or more.

JP2006161017 indicates that the polyoxalate described can be manufactured by a polycondensation reaction with the isosorbide, oxalic acid or its derivative(s), such as an oxalic-acid diester or an oxalic-acid dichloride. When the polyoxalate contains an additional ester unit as an additional repeating unit, a part of the oxalic acid or a derivative thereof is replaced with an additional acid component. Also when the polyoxalate contains an additional ester unit as an additional repeating unit, part of the isosorbide is replaced with an additional alcohol component.

In the examples of JP2006161017 an oxalic acid diphenyl ester is reacted with isosorbide in the presence of a butyltinhydroxyoxide hydrate catalyst to prepare a poly isosorbide oxalate polymer having a glass transition temperature of more than 160° C. The manufacture of polyoxalates with an additional repeating unit was not disclosed and no such polyoxalates with an additional repeating unit were exemplified.

Non-prepublished international patent application PCT/EP2018/063242 describes a polyester copolymer, having a number average molecular weight of equal to or more than 5000 grams/mole and having a glass transition temperature of less than 160° C., containing:
in the range from equal to or more than 25 mole % to equal to or less than 49.9 mole %, based on the total amount of moles of monomer units within the polyester copolymer, of one or more bicyclic diol monomer units, wherein such one or more bicyclic diol monomer units is/are derived from one or more bicyclic diols chosen from the group consisting of isosorbide, isoidide, isomannide, 2,3:4,5-di-O-methylene-galactitol and 2,4:3,5-di-O-methylene-D-mannitol;
in the range from equal to or more than 45 mole % to equal to or less than 50 mole %, based on the total amount of moles of monomer units within the polyester copolymer, of an oxalate monomer unit;
in the range from equal to or more than 0.1 mole % to equal to or less than 25 mole %, based on the total amount of moles of monomer units within the polyester copolymer, of one or more linear C2-C12 diol monomer units, wherein such one or more linear C2-C12 diol monomer units is/are derived from one or more linear C2-C12 diols; and
optionally equal to or more than 0 mole % to equal to or less than 5 mole %, based on the total amount of moles of monomer units within the polyester copolymer, of one or more additional monomer units.

In the examples of PCT/EP2018/063242 the polyester copolymer is prepared by a one-step process comprising polymerizing in one step isosorbide; one or more oxalic diesters and one or more linear C2-C12 diols. PCT/EP2018/063242 also describes the possibility of first reacting the one or more bicyclic diols with the one or more oxalic diesters in the presence of a metal-containing catalyst under polymerization conditions to produce a bicyclic diol-oxalate ester product, whereafter the bicyclic diol-oxalate ester product is subsequently reacted with the one or more linear C2-C12 diols in the presence of a metal-containing catalyst under further polymerization conditions to produce the polyester copolymer. PCT/EP2018/063242, however, does not describe the end groups of such bicyclic diol-oxalate ester product and does not describe the number of monomers in such bicyclic diol-oxalate ester product. In addition, PCT/EP2018/063242 does not illustrate such a two-step process in its examples. Further PCT/EP2018/063242 does not describe the potential use of an oxalic acid and/or an oxalic monoester.

As illustrated in the examples of the present patent application, a one-step polymerization of an cyclic or bicyclic diol, such as isosorbide, an oxalate precursor, such as oxalic acid, and a aliphatic non-cyclic diol, such as 1,4-butanediol, may lead to an inefficient and/or limited incorporation of the cyclic or bicyclic diol into the polyester copolymer and/or an uneven distribution of such cyclic or bicyclic diols, in the polyester copolymer.

For certain polyester copolymer applications a more even distribution of cyclic and/or bicyclic diol monomer units in the polyester copolymer may be desired and/or it may be advantageous to have a process that allows one to incorporate the cyclic and/or bicyclic diols in a polyester copolymer in an efficient, economically attractive manner. Further it can be commercially attractive to have a process that still allows for the production of polyester copolymers having a commercially interesting number average molecular weight. In addition, it can be advantageous and/or economically attractive to be able to use oxalic acid or oxalic monoesters instead of the oxalic diesters mentioned in PCT/EP2018/063242, especially where such oxalic acid or oxalic monoester can be used in the absence of a (transesterification) catalyst.

WO2015/142181 describes a process for preparing a polyester comprising: contacting at least one furandidicarboxylic acid or diester, and one bicyclic diol, such as isosorbide, in order to form an ester product comprising an excess of furandicarboxylate moieties compared to bicyclic diol moieties; and reacting the ester product thus obtained with a saturated, linear or branched, diol comprising from 2 to 10 carbon atoms under polymerization conditions to form the polyester.

As illustrated in example 5 of WO2015/142181, however, the use of such a process, where first an intermediate ester product is formed with the help of a transesterification catalyst, leads to polyester copolymers having an overall molecular weight that is lower than the molecular weight of the polyester copolymer obtained by polymerizing furandidicarboxylic diester, ethylene glycol and isosorbide all in one step as exemplified in examples 2, 3 and 4 of WO2015/142181.

It would be an advancement in the art to provide a process for the production of a polyester copolymer as described in PCT/EP2018/063242, where this process allows for the production of a polyester copolymer that has an even distribution of cyclic or bicyclic diol monomer units, and/or where this process allows for the use of oxalic acid and or oxalic monoesters as monomer, and/or where the cyclic or bicyclic diol can be incorporated in an efficient, economically attractive manner in the polyester copolymer, whilst still allowing for a polyester copolymer to be obtained that has a commercially interesting number average molecular weight (Mn).

### SUMMARY OF THE INVENTION

Such a process for the production of a polyester copolymer has been obtained with the process according to the invention.

Accordingly, the present invention provides a process for the production of one or more polyester copolymers, comprising the steps of:
a) oligomerizing one or more, cyclic or bicyclic, diol monomers with a molar excess of one or more dicarboxylic monomers, which one or more dicarboxylic monomers comprise one or more oxalic monomers chosen from the group consisting of oxalic acid, oxalic monoesters and oxalic diesters, to yield one or more oligomers; and
b) polymerizing the one or more oligomers with one or more primary diol monomers.

Such a process suitably yields one or more polyester copolymers or more suitably a polyester copolymer composition. By a polyester copolymer composition is herein suitably understood a composition comprising one or more polyester copolymers.

The process can advantageously allow one to produce one or more polyester copolymers that, on average, have a more even distribution of cyclic or bicyclic diol monomer units throughout the polyester copolymer chain; and/or to incorporate the cyclic or bicyclic diol more efficiently into the one or more polyester copolymers, and/or to use an oxalic acid and/or oxalic monoester monomer in the preparation of such one or more polyester copolymers, whilst still allowing for a commercially interesting number average molecular weight (Mn) to be obtained.

The obtained one or more polyester copolymers are not known from the prior art and therefore the invention also provides one or more polyester copolymers obtained or obtainable by the above process. Further the invention provides one or more polyester copolymers, having, on average, a monomer unit distribution according to the formula (I):

[—C-A-(-B-A-)ₙ]ₘ (I)

wherein n is a number in the range from equal to or more than 1 to equal to or less than 8; and
wherein m is a number in the range from equal to or more than 2 to equal to or less than 100000; and
wherein A represents an oxalate monomer unit; and
wherein B represents a, cyclic or bicyclic, diol monomer unit; and
wherein C represents a primary C2-C12 diol monomer unit.

Such average monomer unit distribution can suitably be determined as illustrated under the Analytical Methods section of the Examples.

Some of the methods to prepare the oligomer are believed to be novel and inventive in itself. The invention therefore further provides a method for the preparation of one or more oligomers, which method comprises melt mixing one or more, cyclic or bicyclic, diol monomers with one or more oxalic monomers chosen from the group consisting of oxalic acid, oxalic monoesters and oxalic diesters, in a molar ratio of the one or more oxalic monomers to the one or more, cyclic or bicyclic, diol monomers of more than 1.1:1.

Such a process suitably yields an oligomer composition. By an oligomer composition is herein suitably understood a composition comprising one or more oligomers. Such oligomer composition is not described in the prior art and therefore the invention also provides an oligomer composition obtained or obtainable by the above method. The present invention further provides one or more oligomers, which one or more oligomers comprise or consist of:
one or more, cyclic or bicyclic, diol monomer units; and
one or more oxalate monomer units; and
   which one or more oligomers have an average molar ratio of the one or more oxalate monomer units to the one or more, cyclic or bicyclic, diol monomer units of equal to or more than 1.1:1.

The polyester copolymer according to the invention can advantageously be used in industrial applications, such as in films, fibres, injection moulded parts and packaging materials, such as bottles and/or containers.

In addition, therefore the present invention provides a composition containing one or more polyester copolymers as described above and optionally in addition one or more additives and/or one or more additional polymers.

Further the invention provides a procedure for manufacturing an article, comprising the use of one or more polyester copolymers according to the invention.

Still further, the invention provides an article obtained or obtainable by such a procedure for manufacturing an article as described above.

### DETAILED DESCRIPTION OF THE INVENTION

By a “polymer” is herein suitably understood a molecular structure comprising equal to or more than 11 monomer units, more suitably equal to or more than 21 monomer units, even more suitably in the range from equal to or more than 11 to equal to or less than 1000000 monomer units, and most suitably in the range from equal to or more than 21 monomer units to equal to or less than 1000000 monomer units, linked together in a chain.

By “polymerizing” is herein suitably understood the linking of one or more monomers and/or one or more oligomers to produce a composition containing one or more polymers.

By a “polyester” is herein suitably understood a polymer comprising a plurality of monomer units linked via ester functional groups in its main chain. Such an ester functional group is sometimes also referred to as a group with formula Rₐ—C(═O)—O—R_{b}, wherein Rₐ and R_{b}, each independently, are organic groups bonded to the ester functional group via a carbon atom.

By a “polyester copolymer” is herein suitably understood a polyester wherein three or more different kind of monomer units are linked via ester functional groups in the same polymer main chain.

By a “polyester copolymer composition” is herein suitably understood a composition comprising one or more polyester copolymers.

By “oligomerizing” is herein suitably understood the linking of one or more monomers to produce a composition containing one or more oligomers.

By an “oligomer” is herein suitably understood a molecular structure comprising in total in the range from equal to or more than 3 to equal to or less than 21 monomer units, preferably in the range from equal to or more than 3 to equal to or less than 11 monomer units, more preferably in the range from equal to or more than 3 to equal to or less than 9 monomer units, and still more preferably in the range from equal to or more than 3 to equal to or less than 5 monomer units. The oligomer in this invention is sometimes also referred to as an oligoester.

By an “oligoester” is herein suitably understood an oligomer in which the monomers units are linked via by ester functional groups in its main chain.

By an “oligomer composition” is herein suitably understood a composition comprising one or more oligomers.

By a “monomer unit” is herein suitably understood a constitutional unit as contributed by a single monomer or single monomer compound to the molecular structure of an oligomer, polymer or copolymer.

By a “monomer” or “monomer compound” is herein suitably understood a starting compound to be oligomerized or polymerized.

By a “repeating unit” or “repeat unit” is herein suitably understood a part of an oligomer, polymer or copolymer that is repeated successively along the main chain of the oligomer, polymer or copolymer. For a polyester or oligoester according to the present invention any such repeating unit suitably comprises 2 monomer units, one monomer unit derived from a compound having two hydroxy end groups (also referred to as a diol) and one monomer unit derived from a compound having two dicarboxylic acid and/or ester groups (also referred to as a diacid, acid-ester, or diester).

By a “Cx” compound is herein understood a compound having “x” carbon atoms. Similarly, by a “Cy” compound is herein understood a compound having “y” carbon atoms. By a “Cx-Cy” compound is therefore herein understood a compound having in the range from equal to or more than “x” to equal to or less than “y” carbon atoms. For the avoidance of doubt, it is therefore well possible for a Cx-Cy compound to contain more than “x” or less than “y” carbon atoms.

All pressures herein are absolute pressures.

Herein below the monomers used in the oligomerization and/or polymerization and the monomer units in the resulting oligomers and/or polyester copolymers will be described one by one.

The one or more primary diol monomers can be cyclic, linear or branched. Preferably the one or more primary diol monomers are non-cyclic and do not comprise any ring structure. Suitably the one or more primary diol monomers are aliphatic. The one or more primary diol monomers can be saturated or unsaturated, but are preferably saturated. Further the one or more primary diol monomers may or may not comprise heteroatoms such as oxygen, sulfur and/or nitrogen in its main carbon chain. Preferably the one or more primary diol monomers comprise a backbone carbon chain having at least two hydroxyl groups connected to it. More preferably such backbone carbon chain comprises in the range from equal to or more than 2 to equal to or less than 12 carbon atoms. Any branched diol monomers preferably comprise such a C2-C12 backbone carbon chain substituted with one or more alkyl groups, for example one or more C1-C6 alkyl groups, such as methyl, ethyl, a propyl, a butyl, a pentyl or a hexyl.

More preferably the one or more primary diol monomers comprise or consist of one or more, primary, cyclic, linear or branched C2-C12 diol monomers.

Such one or more linear C2-C12 diol monomers preferably have a chemical structure according to formula (II):

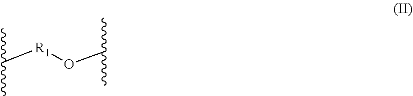

wherein R₁ is a linear organic group. Preferably R₁ is a bivalent linear aliphatic, respectively olefinic, hydrocarbon radical. More preferably R₁ is a bivalent linear aliphatic hydrocarbon radical. Such a bivalent aliphatic group is sometimes also referred to as an “alkylene” group. R₁ may or may not include one or more heteroatoms, such as oxygen (O), sulphur (S) and combinations thereof, within the backbone carbon chain. If a heteroatom is present in the backbone carbon chain, such heteroatom is preferably oxygen. Preferably R₁ comprises a straight backbone carbon chain with no substituents.

The one or more linear C2-C12 diol monomers can be linear diol monomers containing an even or odd number of carbon atoms. The one or more linear C2-C12 diol monomers may for example comprise 2, 3, 4, 5, 6, 7, 8, 9, 10, 11 or 12 carbon atoms. Preferably the one or more linear C2-C12 diol monomers is/are one or more linear diol monomers having a chemical structure according to formula (II), wherein R₁ is an alkylene group with structure —[CH₂]ₖ—, wherein k suitably represents a number of —[CH₂]— groups and wherein k is a number in the range from 1 to 10. The number k can be an even or odd number and suitably k can be 1, 2, 3, 4, 5, 6, 7, 8, 9 or 10. Examples of suitable linear C2-C12 diol monomers include ethyleneglycol (ethane-1,2-diol), propane-1,3-diol, propene-1,3-diol, butane-1,4-diol, butene-1,4-diol, pentane-1,5-diol, pentene-1,5-diol, hexane-1,6-diol, hexene-1,6-diol, hexadiene-1,6-diol, heptane-1,7-diol, heptene-1,7-diol, octane-1,8-diol, octene-1,8-diol, octadiene-1,8-diol, nonane-1,9-diol, nonene-1,9-diol, decane-1,10-diol, decene-1,10-diol, undecane-1,11-diol, undecene-1,11-diol, dodecane-1,12-diol, dodecene-1,12-diol, diethyleneglycol (DEG; 2,2′-Oxydi(ethan-1-ol)), triethyleneglycol (TEG; 2,2′-[Ethane-1,2-diylbis(oxy)]di(ethan-1-ol)), dipropylene glycol (4-Oxa-2,6-heptandiol) and mixtures of two or more thereof.

Most preferably the one or more primary diol monomers is/are chosen from the group consisting of butane-1,4-diol, hexane-1,6-diol, diethyleneglycol, triethyleneglycol and mixtures of one or more of these.

The one or more primary diol monomers is/are preferably obtained and/or derived from a sustainable source. For example, WO 2009/065778 describes the production of succinic acid in a eukaryotic cell, which can for example be subsequently partly hydrogenated to prepare butane-1,4-diol.

The monomer units in the one or more oligomers and/or one or more polyester copolymers that are derived from the one or more primary diol monomers, may herein sometimes also be referred to “primary diol monomer unit” or simply as “primary diol unit”. A monomer unit derived from a linear C2-C12 diol monomer is herein sometimes also referred to as “linear C2-C12 diol monomer unit” or simply as “linear C2-C12 diol unit”.

The one or more, cyclic or bicyclic, diol monomers are preferably secondary diols. That is, the one or more, cyclic or bicyclic diol monomers are preferably secondary, cyclic or bicyclic, diol monomers. In such secondary, cyclic or bicyclic, diol monomers the hydroxyl groups are suitably bound directly to a carbon atom in the ring structure.

In one embodiment the “cyclic or bicyclic diol monomers” are preferably bicyclic diol monomers. In such embodiment, step a) preferably comprises oligomerizing one or more bicyclic diol monomers with a molar excess of the one or more dicarboxylic monomers.

Such a bicyclic diol monomer may suitably comprise a bicyclic diol. The bicyclic diol preferably comprises a ring structure, which ring structure comprises two joined rings, and which ring structure has two hydroxyl groups connected to it. The ring structure of the bicyclic diol can be aromatic or aliphatic. Preferably the ring structure of the bicyclic diol is aliphatic. Thus the bicyclic diol is preferably an aliphatic bicyclic diol. The ring structure of the bicyclic diol can be a saturated or unsaturated ring structure, but is preferably a saturated ring structure. Preferably the ring structure of the bicyclic diol comprises in the range from 6 to 12 carbon atoms. The ring structure of the bicyclic diol may or may not be substituted with one or more alkyl groups, for example one or more C1-C6 alkyl groups, such as methyl, ethyl, propyl, butyl, pentyl or hexyl. The ring structure of the bicyclic diol further may or may not comprise heteroatoms such as oxygen, sulfur and/or nitrogen.

The monomer units in the one or more oligomers and/or one or more polyester copolymers that are derived from the one or more bicyclic diol monomers, may herein sometimes also be referred to “bicyclic diol monomer unit” or simply as “bicyclic diol unit”.

More preferably the one or more, cyclic or bicyclic, diol monomers comprise or consist of one or more bicyclic diols chosen from the group consisting of

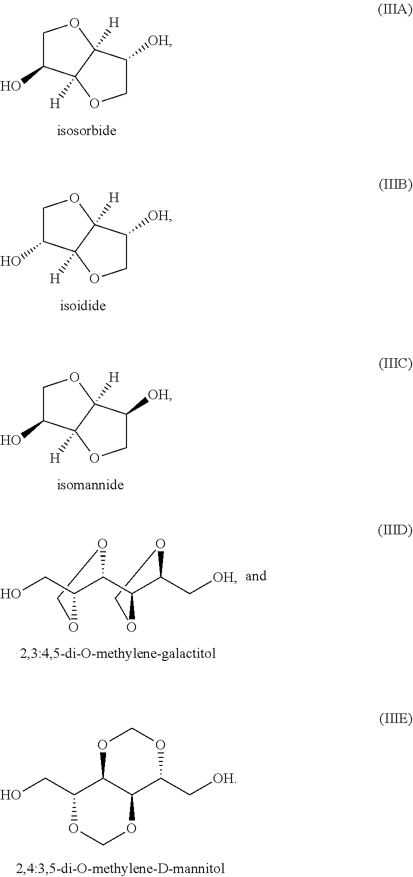

Preferably the one or more bicyclic diols comprise or consist of one or more 1,4:3,6-dianhydrohexitols.

Any bicyclic diol monomer unit derived from such one or more 1,4:3,6-dianhydrohexitols can herein sometimes also be referred to as “1,4:3,6-dianhydrohexitol monomer unit” or simply as “1,4:3,6-dianhydrohexitol unit”.

More preferably the one or more “1,4:3,6-dianhydrohexitol monomer unit”, “1,4:3,6-dianhydrohexitol-derived monomer unit” or “1,4:3,6-dianhydrohexitol unit” comprises or consists of one or more monomer units chosen from the group of monomer units of the formulae (IVA), (IVB) and/or (IVC):

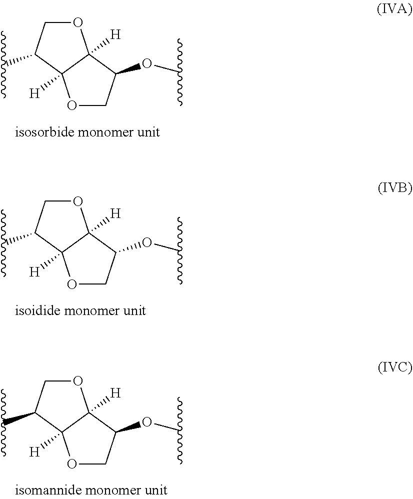

The isosorbide monomer unit exemplified in formulae (IVA) can exist in two three-dimensional structures as exemplified in paragraphs [0021] and [0022] of JP2006161017, and both structures are included herein by reference.

Examples of suitable 1,4:3,6-dianhydrohexitols include isosorbide (1,4:3,6-dianhydro-D-glucidol), isomannide (1,4:3,6-dianhydro-D-mannitol), isoidide (1,4:3,6-dianhydro-L-iditol) and mixtures thereof. The most significant difference among the 1,4:3,6-dianhydrohexitol isomers may be the orientation of the two “hydroxyl” groups. This difference in orientation can result in different orientations of the ester group in the oligomer or copolymer, allowing for several variations in spatial configuration and physical and chemical properties of the oligomer or copolymer.

It is possible for the one or more oligomers and/or one or more polyester copolymers to contain only one isomer of the 1,4:3,6-dianhydrohexitol-derived monomer units or to contain a mixture of two or more isomers of 1,4:3,6-dianhydrohexitol-derived monomer units, for example a mixture of monomer units derived from isosorbide and/or isomannide and/or isoidide. Preferably the 1,4:3,6-dianhydrohexitol-derived monomer unit is a monomer unit derived from isosorbide and/or isoidide. Still more preferably the 1,4:3,6-dianhydrohexitol-derived monomer unit is a monomer unit derived from isosorbide. Most preferably the one or more oligomers and/or one or more polyester copolymers only contains isosorbide monomer units, that is, monomer units derived from isosorbide, and essentially no monomer units derived from isomannide and/or isoidide.

The one or more bicyclic diol monomers are preferably obtained and/or derived from a sustainable biomass material. By a biomass material is herein understood a composition of matter obtained and/or derived from a biological source as opposed to a composition of matter obtained and/or derived from petroleum, natural gas or coal. The biomass material can for example be a polysaccharide, such as starch, or a cellulosic and/or lignocellulosic material. By sustainable is herein understood that the material is harvested and/or obtained in a manner such that the environment is not depleted or permanently damaged. Sustainable biomass material may for example be sourced from forest waste, agricultural waste, waste paper and/or sugar processing residues. Isosorbide, isomannide and isoidide can be suitably obtained by dehydrating respectively sorbitol, mannitol and iditol.

In another embodiment the “cyclic or bicyclic diol monomers” in step a) are preferably cyclic diol monomers. In such embodiment, step a) preferably comprises oligomerizing one or more cyclic diol monomers with a molar excess of the one or more dicarboxylic monomers.

Such a cyclic diol monomer may suitably comprise a cyclic diol. By a cyclic diol is herein understood a diol comprising a ring structure, which ring structure only comprises one ring, and which ring structure has at least two hydroxyl groups connected to it. The cyclic diol is therefore herein also referred to as a mono-cyclic diol. The ring structure of the cyclic diol can be aromatic or aliphatic. Preferably the ring structure is aliphatic. Thus the cyclic diol is preferably an aliphatic cyclic diol. The ring structure of the cyclic diol can be a saturated or unsaturated ring structure, but is preferably a saturated ring structure. Preferably the ring structure of the cyclic diol comprises in the range from 4 to 12 carbon atoms. The ring structure of the cyclic diol may or may not be substituted with one or more alkyl groups, for example one or more C1-C6 alkyl groups, such as methyl, ethyl, propyl, butyl, pentyl or hexyl. The ring structure of the cyclic diol further may or may not comprise heteroatoms such as oxygen, sulfur and/or nitrogen.

Suitably the one or more, cyclic or bicyclic, diol monomers comprise or consist of one or more mono-cyclic diols chosen from the group consisting of 2,2,4,4-tetramethyl-1,3-cyclobutanediol, 2,2,4,4-tetraethyl-1,3-cyclobutanediol, 1,4-di(hydroxymethyl)-cyclohexane, 1,2-di(hydroxymethyl)-cyclohexane and 1,3-di(hydroxymethyl)-cyclohexane.

The monomer units in the one or more oligomers and/or one or more polyester copolymers that are derived from the mono-cyclic diol monomer, may herein sometimes also be referred to “mono-cyclic diol monomer unit”, “mono-cyclic diol unit”, “cyclic diol monomer unit” or simply as “cyclic diol unit”.

The one or more dicarboxylic monomers in step a) comprise one or more oxalic monomers chosen from the group consisting of oxalic acid, oxalic monoesters and oxalic diesters. More preferably the one or more dicarboxylic monomers consist of the one or more oxalic monomers. Most preferably the one or more oxalic monomers are chosen from the group consisting of oxalic acid and oxalic monoesters.

By an oxalic monomer is herein preferably understood an oxalic acid, an oxalic monoester and/or an oxalic diester. The one or more oxalic monomers may suitably have a chemical structure according to formula (V):

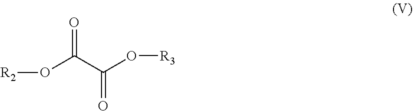

wherein R₂ and R₃, each independently, is hydrogen, a C1-C20 alkyl group, a C2-C20 alkenyl group, a C4-C20 cycloalkyl group, a C4-C20 aryl group or a C5-C20 alkylarylgroup. Such C1-C20 alkyl group, C2-C20 alkenyl group, C4-C20 cycloalkyl group, C4-C20 aryl group or C5-C20 alkylarylgroup may or may not comprise heteroatoms such as oxygen, sulfur and/or nitrogen.

In one preferred embodiment R₂ and/or R₃ are hydrogen. In such embodiment at least one of R₂ and R₃, and preferably both of R₂ and R₃ is/are hydrogen. That is, preferably the one or more oxalic monomers are chosen from the group consisting of oxalic acid and oxalic monoesters. In the current invention such oxalic acid and/or oxalic monoesters are especially advantageous as they can be less expensive than the diesters, and/or may be more easily obtained and/or can be applied in the oligomerization without the requirement of a catalyst being present. In such preferred embodiment the one or more dicarboxylic monomers comprise and preferably consist of one or more oxalic monomers chosen from the group consisting of oxalic acid and oxalic monoesters. If the one or more oxalic monomers are oxalic monoesters, such oxalic monoesters preferably have a chemical structure according to formula (V) wherein one of R₂ and R₃ is hydrogen and the other is a C1-C20 alkyl group or a C2-C20 alkenyl group. Other preferences are as described above.

In another embodiment R₂ and R₃, each independently, can be a group having a chemical structure according to formula (VI):

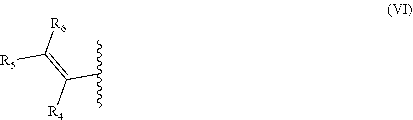

wherein R₄, R₅ and R₆ each independently, represent hydrogen or a C1-C6 alkyl group, or wherein R₄ and R₅ together or R₄ and R₆ together form a C4-C20 cycloalkyl group, a C4-C20 aryl group or a C5-C20 alkylarylgroup. R₄, R₅ and/or R₆ may or may not comprise heteroatoms such as oxygen, sulfur and/or nitrogen.
For example, R₄, R₅ and R₆ each independently, can represent hydrogen or a C1-C4 alkyl group. It is also possible for R₄ and R₅ together or R₄ and R₆ together to form a C5-C10 cycloalkyl group, a C5-C10 aryl group or a C5-C10 alkylarylgroup.
For example, at least one of R₂ and R₃, and preferably both of R₂ and R₃, can be chosen from the group consisting of n-propyl, iso-propyl, n-butyl, iso-butyl, tert-butyl, n-pentyl, iso-pentyl, tert-butyl, phenyl, methylphenyl, ethylphenyl, vinyl (ethenyl), allyl (2-propenyl) and/or 1-propenyl. Most preferably at least one of R₂ and R₃, and preferably both of R₂ and R₃, are phenyl, methylphenyl, allyl and/or vinyl.

Preferably any oxalic diester is a diester of oxalic acid and an alkanol, wherein the alkanol has a pKa of equal to or less than 20.0, more preferably equal to or less than 16.0, even more preferably equal to or less than 15.0 and still more preferably equal to or less than 12.0, such as for example phenol (pKa 10.0), 2-methyl phenol (pKa 10.3), 3-methyl phenol (pKa 10.1), 4-methyl phenol (pKa 10.3), vinyl alcohol (ethenol, pKa 10.5) and/or allyl alcohol (Prop-2-en-1-ol). As a practical minimum the pKa is preferably equal to or more than 7.0.

Most preferably the oxalic diester is di(phenyl)oxalate, di(methylphenyl)oxalate, di(allyl) oxalate, di(vinyl) oxalate, monomethylmonophenyloxalate or a mixture of one or more thereof. The oxalic monomers can comprise a mixture of two or more oxalic diesters. Preferably, however, only one oxalic diester is used, most preferably only di(phenyl)oxalate, only di(methylphenyl)oxalate, only di(allyl)oxalate or only di(vinyl) oxalate is used.

The one or more oxalic monomers are preferably obtained and/or derived from a sustainable source, preferably from a sustainable biomass material. For example the oxalate monomer may be obtained and/or derived from a sustainable biomass material. For example, by use of fungi, such as described in the article of Liaud et al., titled “Exploring fungal biodiversity: organic acid production by 66 strains of filamentous fungi”, published in Fungal Biology and Biotechnology (2014) (published online), an oxalic acid may be produced which may be converted into an oxalic diester by conventional means.

It is especially preferred for the oxalic monomers to be obtained and/or derived from carbon monoxide and/or carbondioxide (CO₂), for example via a process including an electrochemical conversion. For example WO 2014/100828 and WO2015184388 describe the electrochemical conversion of CO₂ to oxalate and oxalic acid and their contents are herein incorporated by reference. The therein mentioned oxalate and oxalic acid can be converted to an oxalic diester by conventional means.

The monomer units in the one or more oligomers and/or one or more polyester copolymers that are derived from the one or more dicarboxylic monomers, may herein be referred to as “carboxylate monomer unit” or simply as “carboxylate unit”.

The monomer units in the one or more oligomers and/or one or more polyester copolymers that are derived from the one or more oxalic monomers, may herein be referred to as “oxalate monomer unit” or simply as “oxalate unit”.

Such oxalate monomer unit may have a chemical structure according to formula (VII):

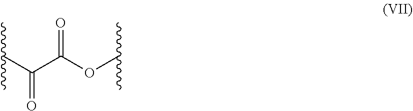

In addition to the one or more oxalic monomers, optionally one or more other dicarboxylic monomers may be present as part of the one or more dicarboxylic monomers in step a). Such a dicarboxylic monomer is preferably a dicarboxylic acid, a dicarboxylic monoester and/or a dicarboxylic diester. More preferably such one or more other dicarboxylic monomers (i.e. other than oxalic monomers) can be one or more, aliphatic or aromatic, linear, cyclic or branched dicarboxylic monomers, preferably having in the range from equal to or more than 3 to equal to or less than 12 carbon atoms, preferably chosen from the group consisting of C3-C12 dicarboxylic diacids, C3-C12 dicarboxylic acid esters and C3-C12 dicarboxylic diesters.

Suitably the one or more dicarboxylic monomers can therefore contain:
one or more dicarboxylic monomers, other than oxalic monomers, which dicarboxylic monomers are preferably chosen from the group consisting of C3-C12 aliphatic diacids, furan didicarboxylic acid, benzoic acid, terephthalic acid and/or monoesters and/or diesters thereof; and
one or more oxalic monomers chosen from the group consisting of oxalic acid, oxalic monoesters and oxalic diesters, more preferably chosen from the group consisting of oxalic acid and oxalic monoesters.

Such other dicarboxylic monomers (i.e. other than oxalic monomers) can for example be chosen from the group consisting of C3-C12 aliphatic diacids, such as butanedioic acid (succinic acid), pentanedioic acid, hexanedioic acid (adipic acid), heptanedioic acid, octanedioic acid (suberic acid), nonanedioic acid, decanedioic acid, undecanedioic acid and dodecanedioic acid; furan didicarboxylic acid; benzoic acid; terephthalic acid; and/or monoesters and/or diesters thereof, such as for example dialkyl esters of such C3-C12 aliphatic diacids, dialkyl esters of furan didicarboxylic acid, dialkyl esters of furan didicarboxylic acid, and/or dialkyl esters of terephthalic acid, where the alkyl groups comprise in the range from 1 to 6 carbon atoms.

Preferably the one or more dicarboxylic monomers contain in the range from equal to or more than 25 mole %, more preferably equal to or more than 50 mole %, still more preferably equal to or more than 75 mole % to equal to or less than 95 mole %, more preferably equal to or less than 99 mole %, still more preferably equal to or less than 99.9 mole % and most preferably equal to or less than 100 mole % of one or more oxalic monomers, based on the total amount of moles of dicarboxylic monomers. The remainder may suitably be other dicarboxylic monomers as for example mentioned herein above.

Preferably the one or more dicarboxylic monomers contain predominantly oxalic monomers, i.e. contain more than 50 mole % oxalic monomers, based on the total amount of moles of dicarboxylic monomers. If present, preferably the one or more other dicarboxylic monomers (i.e. other than oxalic monomers) are present in a lower amount of moles than the oxalic monomers.

If present, the one or more other dicarboxylic monomers (i.e. other than oxalic monomers) are preferably present in an amount from equal to or more than 0.1 mole %, more suitably equal to or more than 1 mole %, still more suitably equal to or more than 5 mole % to equal to or less than 75 mole %, preferably to equal to or less than 50 mole %, more preferably to equal to or less than 25 mole %, based on the total amount of moles of dicarboxylic monomers.

Most preferably, step a) is carried out in the essential absence of any dicarboxylic monomers other than the one or more oxalic monomers. Even more preferably the one or more dicarboxylic monomers consist of only one or more oxalic monomers and no other dicarboxylic monomers are present.

Hence preferably the one or more dicarboxylic monomers consist of one or more oxalic monomers chosen from the group consisting of oxalic acid, oxalic monoesters and oxalic diesters, more preferably chosen from the group consisting of oxalic acid and oxalic monoesters.

In step a), the one or more, cyclic or bicyclic, diol monomers are oligomerized with a molar excess of the one or more dicarboxylic monomers.

Preferably step a) comprises oligomerizing the one or more, cyclic or bicyclic, diol monomers with the one or more dicarboxylic monomers in a molar ratio of the one or more dicarboxylic monomers to the one or more, cyclic or bicyclic, diol monomers that is equal to or more than 1.1:1. More preferably step a) comprises oligomerizing the one or more, cyclic or bicyclic, diol monomers with the one or more dicarboxylic monomers in a molar ratio of the one or more dicarboxylic monomers to the one or more, cyclic or bicyclic, diol monomers in the range from equal to or more than 1.1:1, more preferably equal to or more than 1.5:1, and still more preferably equal to or more than 1.7:1, to equal to or less than 10:1, more preferably equal to or less than 5:1, still more preferably equal to or less than 3:1, even more preferably equal to or less than 2.5:1. Most preferably step a) comprises oligomerizing the one or more, cyclic or bicyclic, diol monomers with the one or more dicarboxylic monomers in a molar ratio of dicarboxylic monomers to cyclic or bicyclic diol monomers in the range from equal to or more than 1.5:1 to equal to or less than 2.5:1, more preferably in the range from equal to or more than 1.7:1 to equal to or less than 2.3:1 and most preferably in the range from equal to or more than 1.9:1 to equal to or less than 2.1:1.

Suitably step a) comprises oligomerizing the one or more, cyclic or bicyclic, diol monomers with the one or more dicarboxylic monomers, wherein the dicarboxylic monomers are present in a molar excess of essentially two times the molar amount of the one or more, cyclic or bicyclic, diol monomers.

Step a) is preferably carried out by melt mixing the one or more, cyclic or bicyclic, diol monomers with a molar excess of the one or more dicarboxylic monomers. Such melt mixing suitably comprises melting of the one or more, cyclic or bicyclic, diol monomers and the one or more dicarboxylic monomers and simultaneously and/or subsequently mixing such. Step a) can be carried out at a wide range of temperatures, but is preferably carried out at a temperature in the range from equal to or more than 70° C., more preferably equal to or more than 90° C. to equal to or less than 175° C., more preferably to equal to or less than 170° C., and most preferably to equal to or less than 160° C., possibly to equal to or less than 150° C.

Step a) is preferably carried out under an inert gas atmosphere. Hence, suitably step a) is carried out in the essential absence of oxygen. For example step a) may suitably be carried out under a constant purging of an inert gas, such as for example nitrogen.

Step a) can be carried out at a wide range of pressures.

For example step a) can be carried out at a pressure in the range from equal to or more than 0.001, more preferably equal to or more than 0.01 to equal to or less than 0.1 MegaPascal absolute (corresponding to about 1 bar absolute). For example the pressure can even be about 0.1 MegaPascal absolute.

Preferably, however, step a) is carried out at a reduced pressure. Step a) may for example be carried out at a pressure in the range from equal to or more than 10.0 mbar (10.0 millibar, corresponding to 1.00 KiloPascal), more preferably equal to or more than 100 mbar (corresponding to 10.0 KiloPascal), to equal to or less than 1.00 bar (corresponding to 100 KiloPascal), more preferably equal to or less than 400 mbar (corresponding to 40.0 KiloPascal).

The mixing in step a) may be carried out in any manner known to be suitable for such purpose by one skilled in the art and may include mechanical mixing and/or static mixing. The oligomerization of step a) can be carried out in a reactor. Such reactor can be any type of reactor known to be suitable by one skilled in the art for an oligomerization, including for example a mechanically stirred reactor.

Step a) may or may not be carried out in the presence of a catalyst. Preferably, step a) is carried out in the essential absence or even complete absence of a transesterification catalyst, more preferably in the essential absence or even complete absence of a catalyst. Especially where the oxalic monomer comprises oxalic acid and/or one or more oxalic mono-esters, such a catalyst is advantageously not required.

If step a) is carried out in the presence of a catalyst, such a catalyst is preferably a catalyst as listed below for step b).

Some of the methods of carrying out step a) are believed to be novel and inventive in itself. The present invention therefore also provides a method for the preparation of one or more oligomers, which method comprises melt mixing one or more, cyclic or bicyclic, diol monomers with one or more oxalic monomers chosen from the group consisting of oxalic acid, oxalic monoesters and oxalic diesters, in a molar ratio of the one or more oxalic monomers to the one or more, cyclic or bicyclic, diol monomers of more than 1.1:1, preferably at a temperature in the range from equal to or more than 70° C. to equal to or less than 170° C., preferably in an inert atmosphere and preferably in the absence of a catalyst. Further preferences for the type of cyclic or bicyclic diol monomers and the type of oxalic monomers are as described above. Preferences for the molar ratio of oxalic monomers to cyclic or bicyclic diol monomers are as described above for the molar ratio of dicarboxylic monomers to cyclic or bicyclic diol monomers. More preferably the molar ratio of oxalic monomers to cyclic or bicyclic diol monomers lies in the range from in the range from equal to or more than 1.1:1 to equal to or less than 10:1, more suitably equal to or less than 5.1. Most preferably the molar ratio of oxalic monomers to cyclic or bicyclic diol monomers lies in the range from 1.5:1 to equal to or less than 2.5:1, more preferably in the range from equal to or more than 1.7:1 to equal to or less than 2.3:1 and most preferably in the range from equal to or more than 1.9:1 to equal to or less than 2.1:1.

Advantageously such a method allows one to obtain an oligomer composition comprising one or more oligomers. Some of such oligomers are not described in the prior art and therefore the invention also provides an oligomer composition, comprising one or more oligomers, obtained or obtainable by the above method. Such an oligomer composition is suitably obtained in an isolated state, i.e. outside a reactor.

The present invention further provides an oligomer composition, comprising one or more oligomers, having an average total number of monomer units in the range from equal to or more than 3 to equal to or less than 11, such one or more oligomers comprising:
one or more, cyclic or bicyclic, diol monomer units; and
one or more oxalate monomer units;
   in a molar ratio of the one or more oxalate monomer units to the one or more, cyclic or bicyclic, diol monomer units of more than 1.1:1.

Due to the molar excess of oxalate monomers units, the one or more oligomers suitably comprise, on average, end-groups that are predominantly derived from the oxalic monomers. The present invention therefore further provides an oligomer composition, comprising one or more oligomers, having an average total number of monomer units in the range from equal to or more than 3 to equal to or less than 11, such one or more oligomers comprising:
one or more, cyclic or bicyclic, diol monomer units; and
one or more oxalate monomer units;
   wherein equal to or more than 90% of the end-groups of the one or more oligomers are acid or ester end-groups.

In analogy to the above, the one or more oligomers, i.e. the oligomer composition, preferably contain an average in the range from equal to or more than 25 mole %, more preferably equal to or more than 50 mole %, still more preferably equal to or more than 75 mole % to equal to or less than 95 mole %, more preferably equal to or less than 99 mole and most preferably equal to or less than 100 mole % of one or more oxalate monomer units, based on the total amount of carboxylate monomer units. Preferably the carboxylate monomer units in the oligomer composition contain predominantly oxalate monomers units. If present, preferably the one or more other carboxylate monomer units (i.e. other than oxalate monomer units) are present in a lower amount than the oxalate monomer units, preferably in an amount from equal to or more than 0.1 mole %, more preferably equal to or more than 1 mole %, to less than 50 mole %, more preferably equal to or less than 5 mole %, based on the total amount of moles of carboxylate monomer units. Even more preferably the one or more carboxylate monomer units consist of only one or more oxalate monomer units and no other carboxylate monomer units are present.

The oligomer composition can suitably comprise oligomers of different chain lengths. Preferably the one or more oligomers, that is, preferably the oligomer composition, have/has an average total number of monomer units in the range from equal to or more than 3 to equal to or less than 11, more preferably in the range from equal to or more than 3 to equal to or less than 9 monomer units, and still more preferably in the range from equal to or more than 3 to equal to or less than 5 monomer units.

Preferably the one or more oligomers), that is, preferably the oligomer composition, have/has a number average molecular weight in the range from equal to or more than 200 to equal to or less than 5000, more preferably in the range from equal to or more than 200 to equal to or less than 4000, still more preferably in the range from equal to or more than 200 to equal to or less than 2000 and most preferably in the range from equal to or more than 200 to equal to or less than 1000.

Preferably the one or more oligomers yielded in step a), that is, preferably the yielded oligomer composition, have/has, on average, a molar ratio of carboxylate monomer units to one or more, cyclic or bicyclic, diol monomer units in the range from more than 1.1:1 to equal to or less than 2:1, more preferably equal to or more than 1.2:1 to equal to or less than 2:1.

Due to the molar excess of dicarboxylic monomers used, the one or more oligomers, respectively, the oligomer composition, preferably comprise/comprises, on average, end-groups that are predominantly derived from the dicarboxylic monomers.

Preferably the oligomer composition comprises equal to or less than 10 mole %, more preferably equal to or less than 5 mole %, still more preferably equal to or less than 1 mole of so-called hydroxyl end groups (also sometimes referred to as alkanol end groups), based on the total amount of moles of end groups. More preferably, based on the total amount of moles of end groups, the one or more oligomers yielded in step a) comprise equal to or more than 90 mole %, more preferably equal to or more than 95%, still more preferably equal to or more than 99 mole % to equal to or less than 100 mole % of end groups that are acid or ester end groups, essentially only acid or ester end groups. The percentages here are unit percentages, also referred to sometimes as mole unit percentages. Most preferably essentially all end groups in the yielded oligomer composition are acid or ester end groups.

In addition to the one or more oligomers, the intermediate product, comprising one or more oligomers, yielded in step a) may comprise unreacted oxalic monomers. Such unreacted oxalic monomers may or may not be removed from the oligomer composition before polymerization of the one or more oligomers in step b).

In one embodiment, the process further comprises that any unreacted oxalic monomers remaining in the oligomer composition yielded in step a) are contacted under polymerization conditions with the one or more linear or branched diols in step b). Not removing such unreacted oxalic monomers allows for such unreacted oxalic monomers to react further with the one or more primary diol monomers in step b) and/or any with any intermediate polyester copolymer in step b).

In another embodiment the process further comprises that any unreacted oxalic monomers remaining in the oligomer composition yielded in step a) are removed from the oligomer composition before polymerizing the one or more oligomers with the one or more primary diol monomers in step b). Preferably at least part of the unreacted oxalic monomers and more preferably essentially all of the unreacted monomers is removed. Removing such unreacted oxalic monomers avoids that such unreacted oxalic monomers can react further with the one or more primary diol monomers in step b) and/or any with any intermediate polyester copolymer in step b). The unreacted oxalic monomers can be removed in any manner known by the skilled person to be suitable therefore. For example any unreacted oxalic monomers can be removed by evaporation or sublimation under vacuum.

In step b) the one or more oligomers are polymerized with the one or more linear or branched diol monomers.

Suitably step a) can be carried out in a first reactor and step b) can be carried out in a second reactor. It is, however, also possible for step a) to be carried out in one reactor, where subsequently step b) is carried out, optionally after removal of unreacted oxalic monomers, in the same reactor.

Step b) can suitably comprise melt polymerization and/or solid state polymerization of the one or more oligomers with the one or more, linear or branched diol monomers, preferably in the presence of a catalyst.

For example, step b) can comprise melt mixing of the monomers in the presence of a metal-containing catalyst (also referred to herein as melt polymerization).

Step b) can be carried out by melt mixing at a wide range of temperatures, but is preferably carried out at a temperature in the range from equal to or more than 175° C., more preferably equal to or more than 180° C., and even more preferably equal to or more than 190° C. to equal to or less than 300° C., more preferably equal to or less than 275° C., and even more preferably equal to or less than 250° C., preferably in the presence of a metal-containing catalyst. The melt mixing can suitably be carried out in a reactor.

Step b) can comprise melt polymerization or a combination of melt polymerization and solid state polymerization, wherein the polyester copolymer product of a melt polymerization step is followed by a solid state polymerization step.

Step b) is preferably carried out under an inert gas atmosphere, preferable in the essential absence of oxygen. For example step a) may suitably be carried out under a constant flow of nitrogen gas.

Preferably step b) is carried out at a reduced pressure. Step b) may for example be carried out at a pressure in the range from equal to or more than 0.01 mbar (corresponding to 1 Pascal), more preferably equal to or more than 0.1 mbar (corresponding to 10 Pascal) to equal to or less than 10.0 mbar (corresponding to 1.0 KiloPascal), more preferably equal to or less than 5.0 mbar (corresponding to 500 Pascal).

The mixing in step a) may be carried out in any manner known to be suitable for such purpose by one skilled in the art and may include mechanical mixing and/or static mixing. The oligomerization of step a) can be carried out in a reactor. Such reactor can be any type of reactor known to be suitable by one skilled in the art for an oligomerization, including for example a mechanically stirred reactor.

Step b) is preferably carried out in the presence of a metal-containing catalyst. Such metal-containing catalyst may for example comprise derivatives of tin (Sn), titanium (Ti), zirconium (Zr), germanium (Ge), antimony (Sb), bismuth (Bi), hafnium (Hf), magnesium (Mg), cerium (Ce), zinc (Zn), cobalt (Co), iron (Fe), manganese (Mn), calcium (Ca), strontium (Sr), sodium (Na), lead (Pb), potassium (K), aluminium (Al), and/or lithium (Li). Examples of suitable metal-containing catalysts include salts of Li, Ca, Mg, Mn, Zn, Pb, Sb, Sn, Ge, and Ti, such as acetate salts and oxides, including glycol adducts, and Ti alkoxides. Examples of such compounds can, for example, be those given in US2011282020A1 in sections [0026] to [0029], and on page 5 of WO 2013/062408 A1. Preferably the metal-containing catalyst is a tin-containing catalyst, for example a tin(IV)- or tin(II)-containing catalyst. More preferably the metal-containing catalyst is an alkyltin(IV) salt and/or alkyltin(II) salt. Examples include alkyltin(IV) salts, alkyltin(II) salts, dialkyltin(IV) salts, dialkyltin(II) salts, trialkyltin(IV) salts, trialkyltin(II) salts or a mixture of one or more of these. These tin(IV) and/or tin(II) catalysts may be used with alternative or additional metal-containing catalysts. Examples of alternative or additional metal-containing catalysts that may be used include one or more of titanium(IV) alkoxides or titanium(IV) chelates, zirconium(IV) chelates, or zirconium(IV) salts (e.g. alkoxides); hafnium(IV) chelates or hafnium(IV) salts (e.g. alkoxides); yttrium(III) alkoxides or yttrium(III) chelates; lanthanum(III) alkoxides or lanthanum chelates; scandium(III) alkoxides or chelates; cerium(III) alkoxides or cerium chelates. An exemplary metal-containing catalyst is n-butyltinhydroxideoxide.

Any solid state polymerization in step b) preferably comprises heating the polyester copolymer in the essential or complete absence of oxygen and water, for example by means of a vacuum or purging with an inert gas.

Where step b) comprises a combination of melt mixing and solid state polymerization (SSP), step b) preferably comprises:
a melt polymerization wherein the one or more oligomers and the one or more primary diol monomers are polymerized in a melt to produce a polyester copolymer melt product;
an optional pelletisation wherein the polyester copolymer melt product is converted into pellets, and the optional drying of the pellets under vacuum or with the help of inert gas purging; and
a solid state polymerization of the polyester copolymer melt product, optionally in the form of pellets, at a temperature above the Tg of the polyester copolymer melt product and below the melt temperature of the polyester copolymer melt product.

Any solid state polymerization in step b) may suitably be carried out at a temperature in the range from equal to or more than 150° C. to equal to or less than 220° C. The solid state polymerization may suitably be carried out at ambient pressure (i.e. 1.0 bar atmosphere corresponding to 0.1 MegaPascal) whilst purging with a flow of an inert gas (such as for example nitrogen or argon) or may be carried out at a vacuum, for example a pressure equal to or below 100 millibar (corresponding to 0.01 MegaPascal).

Any solid state polymerization in step b) may suitably be carried out for a period up to 120 hours, more suitably for a period in the range from equal to or more than 2 hours to equal to or less than 60 hours. The duration of the solid state polymerization may be tuned such that a desired final number average molecular weight for the polyester copolymer is reached.

Further the invention provides a polyester copolymer composition, comprising one or more polyester copolymers having an average monomer unit distribution according to the formula (I):

[—C-A-(-B-A-)ₙ]ₘ (I)

wherein n is a number in the range from equal to or more than 1, preferably equal to or more than 2, to equal to or less than 8, more preferably to equal to or less than 7, still more preferably to equal to or less than 6, even more preferably to equal to or less than 5; and wherein m is a number in the range from equal to or more than 2, preferably equal to or more than 5, more preferably equal to or more than 10, still more preferably equal to or more than 20, to equal to or less than 100000, suitably to equal to or less than 10000; and
wherein A represents an oxalate monomer unit; and
wherein B represents an, cyclic or bicyclic, diol monomer unit; and
wherein C represents a linear or branched diol monomer unit.

The one or more polyester copolymer(s) according to the invention preferably has/have a number average molecular weight of equal to or more than 9000 grams/mole, more preferably of equal to or more than 12000 grams/mole, still more preferably equal to or more than 15000 grams/mole, even more preferably of equal to or more than 17000 grams/mole, and still even more preferably of equal to or more than 20000 grams/mole and preferably of equal to or less than 150000 grams/mole, even more preferably of equal to or less than 100000 grams/mole. All molecular weights herein are determined as described under the analytical methods section of the examples.

The one or more polyester copolymer(s) according to the invention preferably has/have a glass transition temperature (Tg) equal to or more than minus 60° C. (−60° C.), more preferably equal to or more than minus 20° C. (−20° C.), still more preferably equal to or more than 20° C., and/or less than 160° C., preferably equal to or less than 150° C., still more preferably equal to or less than 140° C., yet still more preferably equal to or less than 135° C. and possibly equal to or less than 130° C.

The one or more polyester copolymers obtained or obtainable in the process according to the invention can suitably be combined with additives and/or other polymers before application. Therefore the invention further provides an composition containing one or more polyester copolymers according to the invention and in addition one or more additives and/or one or more additional (other) polymers.

Such composition can for example comprise, as additive, nucleating agents. These nucleating agents can be organic or inorganic in nature. Examples of nucleating agents are talc, calcium silicate, sodium benzoate, calcium titanate, boron nitride, zinc salts, porphyrins, chlorin and phlorin.

The composition according to the invention can also comprise, as additive, nanometric (i.e. having particles of a nanometric size) or non-nanometric and functionalized or non-functionalized fillers or fibres of organic or inorganic nature. They can be silicas, zeolites, glass fibres or beads, clays, mica, titanates, silicates, graphite, calcium carbonate, carbon nanotubes, wood fibres, carbon fibres, polymer fibres, proteins, cellulose fibres, lignocellulose fibres and nondestructured granular starch. These fillers or fibres can make it possible to improve the hardness, the stiffness or the permeability to water or to gases. The composition can comprise from 0.1% to 75% by weight, for example from 0.5% to 50% by weight, of fillers and/or fibres, with respect to the total weight of the composition. The composition can also be of composite type, that is to say can comprise large amounts of these fillers and/or fibres.

The composition can also comprise, as additive, opacifying agents, dyes and pigments. They can be chosen from cobalt acetate and the following compounds: HS-325 Sandoplast® Red BB, which is a compound carrying an azo functional group also known under the name Solvent Red 195, HS-510 Sandoplast® Blue 2B, which is an anthraquinone, Polysynthren® Blue R and Clariant® RSB Violet.

The composition can also comprise, as additive, a processing aid for reducing the pressure in the processing device. A mould-release agent, which makes it possible to reduce the adhesion to the equipment for shaping the polyester, such as the moulds or the rollers of calendering devices, can also be used. These agents can be selected from fatty acid esters and amides, metal salts, soaps, paraffins or hydrocarbon waxes. Specific examples of these agents are zinc stearate, calcium stearate, aluminium stearate, stearamide, erucamide, behenamide, beeswax or Candelilla wax.

The composition can also comprise other additives, such as stabilizers, for example light stabilizers, UV stabilizers and heat stabilizers, fluidifying agents, flame retardants and antistats. It can also comprise primary and/or secondary antioxidants. The primary antioxidant can be a sterically hindered phenol, such as the compounds Hostanox® 0 3, Hostanox® 0 10, Hostanox® 0 16, Ultranox® 210, Ultranox®276, Dovernox® 10, Dovernox® 76, Dovernox® 3114, Irganox® 1010 or Irganox® 1076. The secondary antioxidant can be trivalent phosphorous-comprising compounds, such as Ultranox® 626, Doverphos® S-9228 or Sandostab® P-EPQ.

In addition, the composition can comprise one or more additional polymers other than the one or more polyester copolymers according to the invention. Such additional polymer(s) can suitably be chosen from the group consisting of polyamides, polystyrene, styrene copolymers, styrene/acrylonitrile copolymers, styrene/acrylonitrile/butadiene copolymers, polymethyl methacrylates, acrylic copolymers, poly(ether/imide)s, polyphenylene oxides, such as poly(2,6-dimethylphenylene oxide), polyphenylene sulfide, poly(ester/carbonate)s, polycarbonates, polysulphones, polysulphone ethers, polyetherketones and blends of these polymers.

The composition can also comprise, as additional polymer, a polymer which makes it possible to improve the impact properties of the polymer, in particular functional polyolefins, such as functionalized polymers and copolymers of ethylene or propylene, core/shell copolymers or block copolymers.

The compositions according to the invention can also comprise, as additional polymer(s), polymers of natural origin, such as starch, cellulose, chitosans, alginates, proteins, such as gluten, pea proteins, casein, collagen, gelatin or lignin, it being possible or not for these polymers of natural origin to be physically or chemically modified. The starch can be used in the destructured or plasticized form. In the latter case, the plasticizer can be water or a polyol, in particular glycerol, polyglycerol, isosorbide, sorbitans, sorbitol, mannitol or also urea. Use may in particular be made, in order to prepare the composition, of the process described in the document WO 2010/0102822 A1.

The composition can suitably be manufactured by conventional methods for the conversion of thermoplastics. These conventional methods may comprise at least one stage of melt or softened blending of the polymers and one stage of recovery of the composition. Such blending can for example be carried out in internal blade or rotor mixers, an external mixer, or single-screw or co-rotating or counter-rotating twin-screw extruders. However, it is preferred to carry out this blending by extrusion, in particular by using a co-rotating extruder. The blending of the constituents of the composition can suitably be carried out at a temperature ranging from 220 to 300° C., preferably under an inert atmosphere. In the case of an extruder, the various constituents of the composition can suitably be introduced using introduction hoppers located along the extruder.

The invention also relates to an article comprising one or more polyester copolymers according to the invention or an composition comprising one or more polyester copolymer according to the invention and one or more additives and/or additional polymers.

The polyester copolymer may conveniently be used in the manufacturing of films, fibres, injection moulded parts and packaging materials, such as for example receptacles. As explained above, the use of the polyester copolymer is especially advantageous where such films, fibres, injection moulded parts or packaging materials need to be heat-resistant or cold-resistant.

The article can also be a fibre for use in the textile industry. These fibres can be woven, in order to form fabrics, or also nonwoven.

The article can also be a film or a sheet. These films or sheets can be manufactured by calendering, cast film extrusion or film blowing extrusion techniques. These films can be used for the manufacture of labels or insulators.

This article can also be a receptacle, it being possible for this receptacle to be used for hot filling. This article can be manufactured from the polyester copolymer or a composition comprising a polyester copolymer and one or more additives and/or additional polymers using conventional conversion techniques. The article can also be a receptacle for transporting gases, liquids and/or solids. The receptacles concerned may be baby's bottles, flasks, bottles, for example sparkling or still water bottles, juice bottles, soda bottles, carboys, alcoholic drink bottles, medicine bottles or bottles for cosmetic products, dishes, for example for ready-made meals or microwave dishes, or also lids. These receptacles can be of any size.

The article may for example be suitably manufactured by extrusion-blow moulding, thermoforming, 3-D printing or injection-blow moulding.

The present invention therefore also conveniently provides a method for manufacturing an article, comprising the use of one or more polyester copolymers according to the invention and preferably comprising the following steps: 1) the provision of a polyester copolymer as described above; 2) melting the polyester copolymer, and optionally one or more additives and/or one or more additional polymers, to thereby produce a polymer melt; and 3) extrusion-blow moulding, thermoforming, 3-D printing and/or injection-blow moulding the polymer melt into the article.

The article can also be manufactured according to a process comprising a stage of application of a layer of polyester in the molten state to a layer based on organic polymer, on metal or on adhesive composition in the solid state. This stage can be carried out by pressing, overmoulding, lamination, extrusion-lamination, coating or extrusion-coating.

### EXAMPLES

### Analytical Methods:

### ¹³C NMR Method for Determining the Number Average Molecular Weight (Mn) for an Oligomer Composition.

The average oligomer number average molecular weight was determined by means of quantitative ¹³C spectroscopy performed on a Bruker DRX 500 (500 MHz). To reach a ¹³C spectrum that can be interpreted quantitatively, the following conditions were used. A paramagnetic relaxation agent chromium(III) acetylacetonate (Cr(acac)₃), 34 mg (corresponding to approximately 0.097 mmol) was dissolved under constant stirring in 0.65 ml deuterated dimethylsulfoxide (DMSO-d6). After complete dissolution, 200 mg of the oligomer product were added and dissolved under constant stirring. The resulting solution was transferred to a NMR tube and measured under inverse gated decoupling conditions. This implies that ¹H decoupling is only active during the acquisition of the spectrum. The relaxation delay between scans was set to 10 seconds. The number of scans was set to 4600 scans.

The resulting ¹³C NMR spectrum exhibited, among others, the following:
an integral value for the broad signal at 158.2-159.4 ppm corresponding to the oxalic acid-ester end groups of the macromonomers (x1).
an integral value for the broad signal at 155.6-157.0 ppm corresponding to the oxalic-ester linking groups in the macromonomer (x2).
an integral value for the broad signal at 85.3-86.3 ppm corresponding to one carbon in the isosorbide monomer unit (x3).

By dividing the total area of the two former signals by two (i.e. (x1+x2)/2) and then dividing that value by the total area obtained for the latter signal (x3), the total molar ratio of oxalic acid to isosorbide was calculated. This ratio correlates to the average ratio of oxalate monomer units to isosorbide monomer units in the oligomer composition. As every chain length has a specific ratio of oxalate monomer units to isosorbide monomer units, this ratio can be correlated to an average chain length. This average chain length can be used to calculate an average Mn for the oligomer composition.

### ¹H NMR Method for Determining the Average Monomer Distribution and the Number Average Molecular Weight (Mn) for a Polyester Copolymer Composition.

The average polyester copolymer number average molecular weight was determined by means of quantitative ¹H NMR spectroscopy performed on a Bruker AMX 400 (400.13 MHz). 5 to 20 mg of the polyester copolymer were dissolved in 0.55 ml DMSO-d6. The resulting solution was transferred to a NMR tube and measured.

The number of scans ranged between 16 and 64.

The resulting ¹H NMR spectrum exhibited, among others (as illustrated in formula (VIII)), the following:
an integral value for the broad signal at 4.90-4.97 ppm corresponding to the H3 proton of the isosorbide monomer unit (y1).
an integral value for the broad signal at 4.23-4.38 ppm corresponding to the H7 protons of the 1,4-butanediol monomer unit (y2).
   an integral value for the signal at 4.80 ppm corresponding to the H9 proton of the polyester end group (y3)

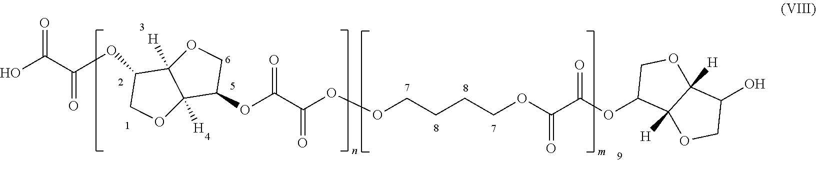

To obtain the molar ratios of the monomer units in the polyester copolymer, the obtained integral value for each signal area was divided by the number of protons that resonate at that frequency for that monomer unit to obtain the area with respect to one proton (thus the value for isosorbide (y1) was divided by one (1) and the value for 1,4-butanediol (y2) was divided by four(4)). These areas with respect to one proton correspond directly to the molar ratio of the monomer units in the polyester copolymer.
To obtain the number average molecular weight of the polyester copolymer, the obtained integral values corresponding to one proton for the monomer units isosorbide (y1) and 1,4-butanediol (y2) were divided by the integral value of end group signal of the polyester (y3). This corresponds to the average number of isosorbide-oxalate repeat units, respectively the average number of butadiol-oxalate repeat units, in the final polyester copolymer and allows one to calculate the average monomer distribution of the one or more polyester copolymers in the polyester copolymer composition. Multiplication of this average numbers of repeat units with the molecular weight of the respective repeat unit (the molecular weight of the isosorbide-oxalate repeat unit is 230.17 grams/mole, respectively, the molecular weight of the butadiol-oxalate repeat unit is 176.15 grams/mole), addition of the two values and addition of the molecular weight of the isosorbide-oxalate repeat unit (to include the molecular weight of the end-group) allows one to calculate the number average molecular weight Mn of the one or more polyester copolymers in the polyester copolymer composition.

### DSC Method for Determining the Glass Transition Temperature (Tg) of the Polyester Copolymer.

The glass transition temperature of the polyester copolymers in the below examples was determined using differential scanning calorimetry (DSC) with heating rate 10° C./minute in a nitrogen atmosphere. In the second heating cycle, a glass transition, (Tg), was observed.

### Example 1a Preparation of an Isosorbide-Oxalic Acid Oligomer

10.003 grams (g) (corresponding to 68.4 millimol (mmol)) of isosorbide (to be abbreviated as ISO hereinafter) and 12.630 g (corresponding to 140.28 mmoles) oxalic acid (to be abbreviated as OA hereinafter) were weighed in a 250 milliliter (ML) glass three-neck round bottom flask (further referred to as the glass reactor). The molar ratio of moles oxalic acid to moles isosorbide was about 2.05:1.00. No catalyst or additives were added. The glass reactor was equipped with a nitrogen gas inlet and a mechanical overhead stirrer. In addition the glass reactor was connected via a distillation head to a receiving flask with a vacuum outlet. The distillation head was not water-cooled but was kept at ambient temperature (about 20° C.) by air. The glass reactor was heated by means of an oil bath.

The glass reactor contents were heated to a temperature of 110° C. under a nitrogen flow (2-3 bubbles/second). During such heating a melt was formed (the exact melt temperature could not be established but a melt was formed at a temperature above approximately 70° C.).

The glass reactor contents were kept at a temperature of 110° C. for 45 minutes, whilst stirring at a stirring rate of approximately 100 rounds per minute (rpm). Some water condensation was observed indicating the start of the reaction.

Subsequently the glass reactor contents were heated to a temperature of 140° C. and kept at 140° C. for 1 hour (h). It was visually observed that the viscosity of the glass reactor contents increased.

Hereafter unreacted oxalic acid was removed by closing the nitrogen gas inlet and applying a vacuum to the glass reactor whilst continuing stirring at 140° C. for 3 hours. A 150 milligrams sample was taken and no oxalic acid could be detected in such sample by ¹³C NMR spectroscopy. A brown melt was recovered from the glass reactor under a positive nitrogen flow. After removal from the glass reactor the brown melt solidified and was crushed into a powder. The powder was analyzed and found to contain oligomers and is further herein referred to as oligomer composition.

The average Mn for the obtained oligomer composition was 890 grams/mole, as determined by the method listed above under “Method for determining the average number average molecular weight (Mn) for an oligomer composition”. The average molecular weight of the oligomers in turn indicated that on average the oligomers in the oligomer composition comprised 4 isosorbide monomer units and 5 oxalic acid monomer units.

### Example 1b Preparation of One or More Polyester Copolymers

2 grams (corresponding to an average of about 2.25 millimol when considering the average number average molecular weight (Mn) of the oligomer composition in example 1 (890 grams/mole) and 0.509 grams of 1,4-butanediol (corresponding to about 5.66 millimol) were weighed in a 250 milliliter (ML) glass three-neck round bottom flask (further referred to as the glass reactor). The glass reactor was equipped with a nitrogen inlet and a mechanical overhead stirrer. In addition the glass reactor was connected via a distillation head to a receiving flask with a vacuum outlet. The glass reactor contents were heated to a temperature of 140° C. and stirred at 100 rpm for 5 hours under a constant nitrogen flow. Hereafter, the pressure was decreased to 2 millibar within 10 minutes. Subsequently the reaction temperature was stepwise increased to a temperature of 180° C. over 130 minutes and kept at a temperature of 180° C. for 1 hour. The temperature was subsequently gradually increased to 210° C. over 25 minutes and kept at a temperature of 210° C. for 80 minutes. Subsequently the reactor was brought to atmospheric pressure (corresponding to about 0.1 MegaPascal) by flushing with nitrogen. 15 Milligrams of a titanium(IV)butoxide (Ti(OBu)₄) catalyst (corresponding to about 0.04 millimol) was added to the melt under a positive nitrogen flow. A vacuum of 1.4 millibar was applied to the glass reactor and it was visually observed that the reactor contents became more viscous.

The reaction temperature of 210° C. was maintained for 60 minutes and was then gradually increased to 225° C. over 60 minutes. When a temperature of 225° C. was reached, the reaction was stopped by flushing the system with nitrogen and the product was discharged under a positive nitrogen flow.

The properties of the resulting polyester copolymer are summarized in Table 1.

### Comparative Example A, Preparation of One or More Polyester Copolymers

Isosorbide (1.495 g, 10.26 mmol), oxalic acid (1.54 g, 16.95 mmol) and 1,4-butanediol (0.744 g, 8.21 mmol) were weighed in a 250 ml three-neck round bottom flask equipped with a N₂ inlet, a mechanical overhead stirrer and a distillation head connected to a receiving flask with a vacuum outlet. The reaction mixture was heated to 140° C. and stirred at 55 rpm for 2 hours under a constant N₂ flow (2-3 bubbles/second). After, the pressure was decreased to 1.5 mbar within 10 minutes. The reaction temperature was increased to 160° C. over 30 minutes and kept for 10 minutes. Subsequently, the reaction temperature was increased to 180° C. over 15 minutes and kept for 80 minutes. The temperature was subsequently increased to 210° C. over 20 minutes and kept for 50 minutes. The reactor was brought to atmospheric pressure by flushing with N₂ and Ti(OBu)₄ (15 mg, 0.04 mmol) was added to the melt under a positive N₂ flow. A vacuum of 1.4 mbar was applied to the glass reactor and it was visually observed that the reactor contents became more viscous. The reaction temperature of 210° C. was maintained for 60 minutes and was then increased to 225° C. over 20 minutes and kept for 10 minutes. Afterwards, the reaction was stopped by flushing the system with N₂ and the resulting polyester copolymer composition was discharged under a positive N₂ flow. Some colorless liquid droplets condensed on the inside of the reactor throughout the reaction. Analysis of the droplets on the reactor walls by ¹H NMR revealed that these droplets were largely constituted by unreacted isosorbide.

Samples to monitor the reaction progress were taken throughout the reaction. The system was flushed with N₂ and samples were taken for analysis under a positive N₂ flow. The properties of the resulting polyester copolymer are summarized in Table 1.

TABLE I
Properties for the one or more polyester coplymers obtained
examples 1a and 1b and comparative example A.

| | One or more polyester | One or more polyester |
|---|---|---|
| | copolymers of | copolymers of |
| | Examples 1a and 1b | Comparative example A |
| Mn by by ¹H NMR | 13244 | 13399 |
| (grams/mole) | | |
| ISO:BuD | 61:39 | 56:44 |
| molar ratio in feed | (about 1.56) | (about 1.25) |
| ISO:BuD ratio of | 63:37 | 46:54 |
| repeat units in | (about 1.70) | (about 0.85) |
| polyester copolymer | | |
| by ¹H NMR | | |
| % mole ISO in | 31.5% | 23% |
| polyester copolymer. | | |
| Tg | 83.7° C | 55.1° C. |

* Mn = number average molecular weight

1. A process for the production of one or more polyester copolymers, comprising the steps of:
a) oligomerizing one or more, cyclic or bicyclic, diol monomers with a molar excess of one or more dicarboxylic monomers, which one or more dicarboxylic monomers comprise one or more oxalic monomers chosen from the group consisting of oxalic acid, oxalic monoesters and oxalic diesters, to yield one or more oligomers; and
b) polymerizing the one or more oligomers with one or more primary diol monomers.

2. The process according to claim 1, wherein the one or more primary diol monomers comprise or consist of one or more, cyclic, linear or branched, primary C2-C12 diols.

3. The process according to claim 1 or 2, wherein the one or more, cyclic or bicyclic, diol monomers comprise or consist of one or more bicyclic diols chosen from the group consisting of isosorbide, isoidide, isomannide, 2,3:4,5-di-O-methylene-galactitol and 2,4:3,5-di-O-methylene-D-mannitol.

4. The process according to claim 1, wherein the one or more, cyclic or bicyclic, diol monomers comprise or consist of one or more mono-cyclic diols chosen from the group consisting of 2,2,4,4-tetramethyl-1,3-cyclobutanediol, 2,2,4,4-tetraethyl-1,3-cyclobutanediol, 1,4-di(hydroxymethyl)-cyclohexane, 1,2-di(hydroxymethyl)-cyclohexane and 1,3-di(hydroxymethyl)-cyclohexane.

5. The process according to claim 1, wherein the one or more dicarboxylic monomers contain:
one or more dicarboxylic monomers, other than oxalic monomers, which dicarboxylic monomers are preferably chosen from the group consisting of C3-C12 aliphatic diacids, furan didicarboxylic acid, benzoic acid, terephthalic acid, and/or monoesters and/or diesters of these; and
one or more oxalic monomers chosen from the group consisting of oxalic acid, oxalic monoesters and oxalic diesters.

6. The process according to claim 1, wherein the one or more dicarboxylic monomers consist of one or more oxalic monomers chosen from the group consisting of oxalic acid, oxalic monoesters and oxalic diesters.

7. The process according to claim 1, wherein the one or more oxalic monomers are chosen from the group consisting of oxalic acid and oxalic monoesters.

8. The process according to claim 1, wherein step a) comprises oligomerizing the one or more, cyclic or bicyclic, diol monomers with the one or more dicarboxylic monomers in a molar ratio of the one or more dicarboxylic monomers to the one or more, cyclic or bicyclic, diol monomers that is equal to or more than 1.1:1.

9. The process according to claim 1, wherein step a) comprises oligomerizing the one or more, cyclic or bicyclic, diol monomers with the one or more dicarboxylic monomers in a molar ratio of the one or more dicarboxylic monomers to the one or more, cyclic or bicyclic, diol monomers in the range from equal to or more than 1.9:1 to equal to or less than 2.1:1.

10. The process according to claim 1, wherein the method further comprises removing any unreacted oxalic acid and/or oxalic diester from the one or more oligomers before polymerizing the one or more oligomers with the one or more linear or branched diols.

11. The process according to claim 1, wherein any unreacted oxalic acid and/or oxalic diester is not removed from the one or more oligomers and the complete composition yielded in step a) is contacted under polymerization conditions with the one or more linear or branched diols in step b).

12. A method for the preparation of one or more oligomers, which method comprises melt mixing one or more, cyclic or bicyclic, diol monomers with one or more oxalic monomers chosen from the group consisting of oxalic acid, oxalic monoesters and oxalic diesters, in a molar ratio of the one or more oxalic monomers to the one or more, cyclic or bicyclic, diol monomers of more than 1.1:1.

13. The method according to claim 11, wherein the one or more oxalic monomers are chosen from the group consisting of oxalic acid and oxalic monoesters.

14. An oligomer composition, comprising one or more oligomers, obtained or obtainable by the method of claim 12.

15. An oligomer composition, comprising one or more oligomers, having an average total number of monomer units in the range from equal to or more than 3 to equal to or less than 11, such one or more oligomers comprising:
one or more, cyclic or bicyclic, diol monomer units; and
one or more oxalate monomer units;
wherein equal to or more than 90% of the end-groups of the one or more oligomers are acid or ester end-groups.

16. An oligomer composition according to claim 15, wherein the one or more oligomers have a number average molecular weight in the range from equal to or more than 200 to equal to or less than 5000.

17. (canceled)

18. One or more polyester copolymers, having, on average, a monomer unit distribution according to the formula (I):
[—C-A-(-B-A-)ₙ]ₘ (I)
wherein n is a number in the range from equal to or more than 1 to equal to or less than 8; and
wherein m is a number in the range from equal to or more than 2 to equal to or less than 100000; and
wherein A represents an oxalate monomer unit; and
wherein B represents an cyclic or bicyclic, diol monomer unit; and
wherein C represents a primary C2-C12 diol monomer unit.

19. The one or more polyester copolymers according to claim 18, having a number average molecular weight of equal to or more than 5000 grams/mole and/or having a glass transition temperature of less than 160° C.

20. (canceled)

21. (canceled)

22. (canceled)

23. (canceled)

24. (canceled)

25. The one or more polyester copolymers according to claim 18, further comprising one or more additives and/or one or more additional polymers.
